(19) United States
(12) Patent Application Publication
(10) Pub. No.: US 2026/0312246 A1
(43) Pub. Date: Oct. 8, 2026

(54) ELECTRODE FOR SECONDARY BATTERY AND SECONDARY BATTERY INCLUDING THE ELECTRODE

(71) Applicant: SAMSUNG SDI CO., LTD., Yongin-si, Gyeonggi-do (KR)

(72) Inventor: Kyungtae KIM, Yongin-si, Gyeonggi-do (KR)

(21) Appl. No.: 19/211,731

(22) Filed: May 19, 2025

(30) Foreign Application Priority Data
Sep. 26, 2024 (KR) 10-2024-0130951

(51) Int. Cl. H01M 50/533; H01M 50/107; H01M 50/152

(52) U.S. Cl. CPC H01M 50/533; H01M 50/107; H01M 50/152

(57) ABSTRACT

An electrode for a secondary battery may include a substrate including a conductive metal material. The substrate may include coated portions to which an active material is applied at ends of the substrate and an uncoated portion where no active material is applied and the substrate is exposed. An electrode tab is joined to the uncoated portion of the substrate. The electrode tab may include a joined portion joined to the uncoated portion of the substrate, and a protrusion portion protruding from the uncoated portion and comprising a plurality of segmented portions connected to the joined portion.

### CROSS-REFERENCE TO RELATED APPLICATION

The present application claims priority to and the benefit of Korean Application No. 10-2024-0130951, filed on Sep. 26, 2024, in the Korean Intellectual Property Office, the entire disclosure of which is incorporated by reference herein.

### BACKGROUND

### Field

Aspects of embodiments of the present disclosure relate to an electrode for a secondary battery and a secondary battery including the electrode.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

A rapid temperature rise may occur in a secondary battery due to various events such as a short circuit in an electric circuit or an application of a high current. Such operation abnormalities may affect the intrinsic characteristics of secondary batteries, resulting in performance degradation or a fire in the case of a thermal runaway.

The above information disclosed in this Background section is for enhancement of understanding of the background of the present disclosure, and therefore, it may contain information that does not constitute related (or prior) art.

### SUMMARY

Aspects of embodiments of the present disclosure provide an electrode for a secondary battery that is capable of rapid insulation in a case where an event occurs due to an external short circuit, and a secondary battery including the electrode.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

According to some embodiments of the present disclosure, an electrode for a secondary battery may include a substrate including a conductive metal material, with the substrate including (i) coated portions to which an active material is applied at ends of the substrate and (ii) an uncoated portion where no active material is applied and the substrate is exposed, and an electrode tab joined to the uncoated portion of the substrate, wherein the electrode tab may include a joined portion joined on the uncoated portion of the substrate and a protrusion portion protruding from the uncoated portion of the substrate and including a plurality of segmented portions connected to the joined portion.

According to some embodiments of the present disclosure, each of the segmented portions may be rectangular shaped.

According to some embodiments of the present disclosure, the segmented portions are adjacent and spaced apart from each other.

According to some embodiments of the present disclosure, widths of the first segmented portions may be equal.

According to some embodiments of the present disclosure, the protrusion portion may include at least two segmented portions.

According to some embodiments of the present disclosure, the segmented portions are first segmented portions, and the joined portion may include a plurality of second segmented portions, with each of the second segmented portions being connected to the first segmented portions.

According to some embodiments of the present disclosure, the protrusion portion may further include a connecting portion connecting the segmented portions at an end that is away from the joined portion in a longitudinal direction of the segmented portions.

According to some embodiments of the present disclosure, the electrode tab may be a positive electrode tab.

According to some embodiments of the present disclosure, the joined portion may be joined to the uncoated portion by welding.

According to some embodiments of the present disclosure, an electrode for a secondary battery may include a substrate including a conductive metal material, the substrate including (i) coated portions to which an active material is applied at ends of the substrate and (ii) an uncoated portion where no active material is applied and the substrate is exposed, and an electrode tab joined to the uncoated portion of the substrate, wherein the electrode tab may include a joined portion joined to the uncoated portion of the substrate, and a protrusion portion protruding from the uncoated portion of the substrate and including at least one penetration portion.

According to some embodiments of the present disclosure, the at least one penetration portion may be rectangular shaped.

According to some embodiments of the present disclosure, the at least one penetration portion may be spaced apart from the joined portion.

According to some embodiments of the present disclosure, the protrusion portion may include a plurality of segmented portions formed by segmenting a part of the protrusion portion by the at least one penetration portion.

According to some embodiments of the present disclosure, widths of the segmented portions may be equal.

According to some embodiments of the present disclosure, the electrode tab may be a positive electrode tab.

According to some embodiments of the present disclosure, the joined portion may be joined to the uncoated portion by welding.

According to some embodiments of the present disclosure, a secondary battery may include an electrode assembly including a first electrode, a second electrode, and a separator positioned between the first electrode and the second electrode, a case accommodating the electrode assembly and including a bottom portion electrically connected to the second electrode, a sidewall portion connected to the bottom portion, and an upper opening facing the bottom portion, and a cap assembly joined to the case to cover the opening, wherein the first electrode may include a substrate including a conductive metal material, the substrate including (i) coated portions to which an active material is applied at ends of the substrate and (ii) an uncoated portion where no active material is applied and the substrate is exposed, and an electrode tab joined to the uncoated portion, wherein the electrode tab may include a joined portion joined to the uncoated portion of the substrate, and a protrusion portion protruding from the uncoated portion of the substrate and electrically connected to the cap assembly, the protrusion portion including at least one penetration portion.

According to some embodiments of the present disclosure, the at least one penetration portion may be rectangular shaped.

According to some embodiments of the present disclosure, the case may be cylindrical.

According to some embodiments of the present disclosure, a portion positioned between the at least one penetration portion of the protrusion portion may be configured to ruptured when a short circuit occurs during operation of the secondary battery.

According to some embodiments of the present disclosure, because the secondary battery includes the electrode tabs having the multi-align structure including multiple tabs with a small width or thickness, rapid insulation is possible in a case where an event such as an external short circuit occurs.

According to some embodiments of the present disclosure, because the multi-tabs with a small width or thickness are used as the electrode tabs in the secondary battery, the resistance applied to each electrode tab may be high. Accordingly, each electrode tab is easily broken in a case where a specific event occurs. Accordingly, side reactions and thermal runaway caused by overcurrent inside the secondary battery may be prevented.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a secondary battery according to some embodiments of the present disclosure.

FIG. 2 illustrates the cap assembly of the secondary battery according to some embodiments of the present disclosure.

FIG. 3 illustrates an electrode for a secondary battery according to some embodiments of the present disclosure.

FIG. 4 illustrates an electrode for a secondary battery according to some embodiments of the present disclosure.

FIG. 5 illustrates an electrode for a secondary battery according to some embodiments of the present disclosure.

FIG. 6 illustrates an electrode for a secondary battery according to some embodiments of the present disclosure.

FIG. 7 illustrates an exploded perspective view of a secondary battery including an electrode for a secondary battery as shown in FIG. 6.

FIG. 8 illustrates a mechanism by which the secondary battery is insulated in a low resistance region according to some embodiments of the present disclosure.

FIGS. 9 to 11 illustrate an example of a method of manufacturing an electrode tab according to an embodiment of the present disclosure.

FIG. 12 illustrates a flowchart of a method of manufacturing an electrode tab according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. In addition, it will be understood that when a component is referred to as being “linked,” “coupled,” or “connected” to another component, the elements may be directly “coupled,” “linked” or “connected” to each other, or another component may be “interposed” between the components”.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, the sizes and relative sizes of layers and regions shown in the drawings may be exaggerated for clarity of description. That is, the sizes shown in the drawings are only for convenience of understanding and are not limited thereto. In addition, the same reference numerals denote the same elements throughout the specification.

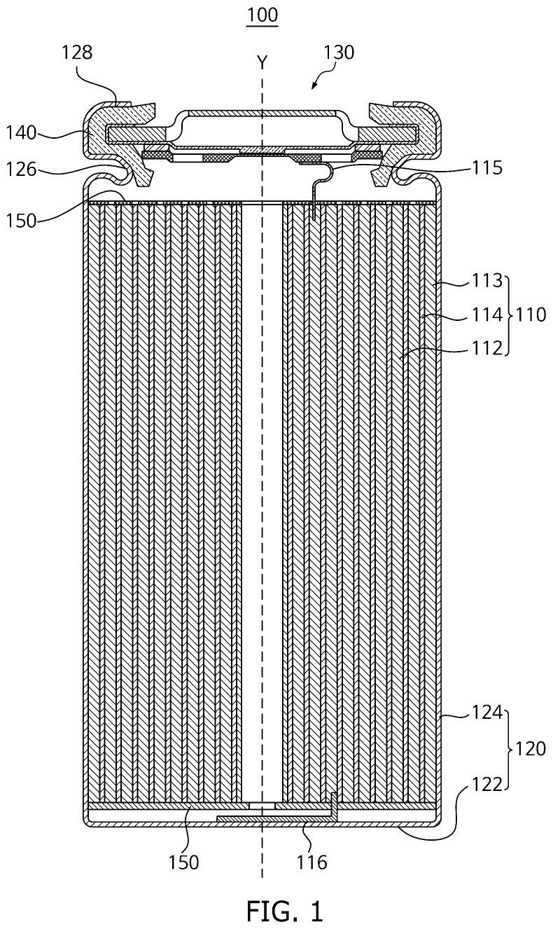

FIG. 1 illustrates a secondary battery 100 according to some embodiments of the present disclosure. Referring to FIG. 1, the secondary battery 100 according to some embodiments of the present disclosure includes an electrode assembly 110. A case 120 accommodates the electrode assembly 110 and an electrolyte therein. A cap assembly 130 is joined to an opening of the case 120 to seal the case 120, and an insulating plate 150 positioned between the electrode assembly 110 and the cap assembly 130 within the case 120.

The electrode assembly 110 may include a first electrode 112 and a second electrode 113 with a separator 114 provided therebetween. The electrode assembly 110 may be wound in a jelly-roll shape with respect to a winding axis Y.

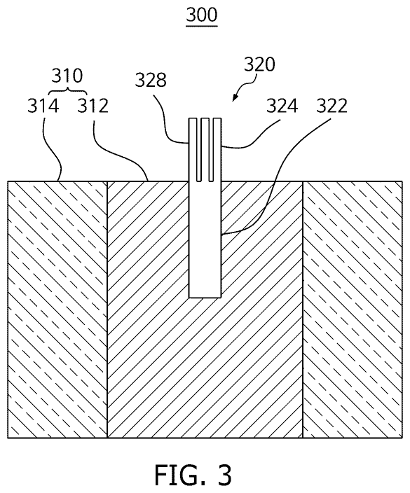

The first electrode 112 may include a first substrate and a first active material layer positioned on the first substrate. A first electrode tab 115 may be formed as a first uncoated portion of the first substrate where the first active material layer is not provided. The first electrode tab 115 may be electrically connected to the cap assembly 130. The first electrode 112 or the first electrode tab 115 may include at least a part of any one of the electrodes for a secondary battery according to the embodiments disclosed in FIGS. 3 to 6 of the present disclosure.

The second electrode 113 may include a second substrate and a second active material layer positioned on the second substrate. A second electrode tab 116 may be provided as a second uncoated portion of the second substrate where the second active material layer is not positioned. The second electrode tab 116 may be electrically connected to the case 120. The first electrode tab 115 and the second electrode tab 116 may extend in opposite directions.

The first electrode 112 may function as a positive electrode. In such a case, the first substrate may be formed from, for example, aluminum foil, and the first active material layer may include, for example, a transition metal oxide. The second electrode 113 may function as a negative electrode. In such a case, the second substrate may be formed from, for example, copper foil or nickel foil, and the second active material layer may include, for example, graphite.

The separator 114 may function to prevent a short circuit from occurring between the first electrode 112 and the second electrode 113 while allowing movement of lithium ions. The separator 114 may include, for example, a polyethylene film, a polypropylene film, a polyethylene-polypropylene film, and the like.

The case 120 may form the exterior of the secondary battery 100 together with the cap assembly 130. The case 120 may include a sidewall portion 124 having an approximately cylindrical shape and a bottom portion 122 connected to one side of the sidewall portion 124. A beading portion 126 deformed toward the inside of the case 120 may be formed on the sidewall portion 124, and a clamping portion 128 bent toward the inside may be formed on the opening side end of the sidewall portion 124.

The beading portion 126 may prevent the electrode assembly 110 from moving within the case 120 and facilitate the seating of the gasket 140 and the cap assembly 130. The clamping portion 128 may firmly fix the cap assembly 130 by pressurizing the edge of the cap assembly 130 through the gasket 140. The case 120 may be made of, for example, nickel-plated iron.

The insulating plate 150 may be positioned in contact with the electrode assembly 110 below the beading portion 126, and a tab opening for withdrawing the first electrode tab 115 may be provided in the insulating plate 150. The cap assembly 130, which is electrically connected to the first electrode 112 by the first electrode tab 115, faces the electrode assembly 110 with the insulating plate 150 provided therebetween, and may be maintained in a state of being insulated from the electrode assembly 110 by the insulating plate 150.

In an embodiment, the positive electrode corresponding to the first electrode 112 of the secondary battery 100 may include a current collector and a positive electrode active material layer formed on the current collector. The positive electrode active material layer may include a positive electrode active material and may further include a binder and/or a conductive material.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

For example, the positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Aluminum may be used as the current collector, but is not limited thereto.

The negative electrode corresponding to the second electrode 113 of the secondary battery 100 may include a current collector and a negative electrode active material layer positioned on the current collector. The negative electrode active material layer may include a negative electrode active material and may further include a binder and/or a conductive material.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

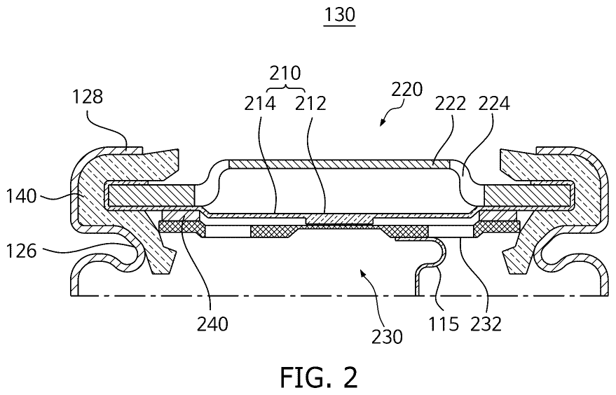

FIG. 2 illustrates the cap assembly 130 of the secondary battery 100 according to some embodiments of the present disclosure. Referring to FIG. 2, the cap assembly 130 may include a vent 210, an upper cap 220, a lower cap 230, a beading portion 126, a gasket 140, and a communication hole 232.

According to an embodiment, the vent 210 may be positioned above the lower cap 230. The vent 210 may be insulated from the cap-down 230 by the insulating layer 240 positioned on the outer upper surface of the lower cap 230. The vent 210 may be positioned to surround a region of the outer upper surface of the upper cap 220 and the outer surface of the upper cap 220.

According to an embodiment, the vent 210 may include a protrusion portion 212 and a rupture portion 214. The protrusion portion 212 may protrude downward from the center of the vent 210. The protrusion portion 212 may be electrically connected to the first electrode 112 through the first electrode tab 115.

The rupture portion 214 rupture by the pressure of gas flowed through a plurality of communication holes 232. The thickness of the rupture portion 214 may be formed based on the pressure of the gas at which the rupture portion 214 is ruptured. That is, the rupture portion 214 may be formed to have a thin thickness so that the rupture portion 214 is ruptured by a lower gas pressure. The rupture portion 214 may be spaced apart from each communication hole 232 or may be offset from each communication hole 232. When the rupture portion 214 is ruptured, the protrusion portion 212 may be separated from the lower cap 230. The vent 210 may be formed with a step so as to be easily separated from the lower cap 230.

According to an embodiment, the clamping portion 128 may be formed to surround a region of the outer upper surface and the outer surface of the upper cap 220. For example, the clamping portion 128 may be formed using a crimping jig after the upper cap 220 is seated on the vent 210. The upper cap 220 may be fixed to the vent 210 by the clamping portion 128.

According to an embodiment, a plurality of welding portions (not shown) may be formed on the clamping portion 128. The welding portions may be formed symmetrically with respect to the center of the vent 210, but the present disclosure is not limited thereto. The adjacent welding portions may be formed at regular intervals, but the present disclosure is not limited thereto. Welding may be performed on the welding portions so that a welding mark (not shown) may be formed in a portion where the outer upper surface of the upper cap 220 and the vent 210 come into contact with each other.

According to an embodiment, the lower cap 230 may be positioned below the vent 210. The lower cap 230 may be formed with a step according to the shape of the vent 210. An insulating layer 240 may be positioned on a region of the outer upper surface of the lower cap 230 to provide insulation from the vent 210. A region of the outer lower surface of the lower cap 230 may come into contact with the gasket 140.

According to an embodiment, the protrusion portion 212 of the vent 210 may be positioned in the center of the lower cap 230. The lower cap 230 may include a plurality of communicating holes 232 spaced apart in the central portion thereof. The lower cap 230 and the vent 210 may be electrically connected to the first electrode 112 through the first electrode tab 115.

According to an embodiment, the communication holes 232 may be spaced apart from each other in the central portion of the lower cap 230. Gases formed inside the secondary battery 100 may flow through the communication holes 232. The rupture portion 214 of the vent 210 may be positioned on each of the communication holes 232. In some embodiments, the rupture portion 214 of the vent 210 may be offset from each of the communication holes 232. In the process of charging and discharge of the secondary battery 100, the electrolyte may be decomposed to form gas. The formed gas may flow through the communication holes 232 formed in the lower cap 230. The rupture portion 214 of the vent 210 may be ruptured by receiving the pressure of the gas that flows through the communication holes 232.

According to an embodiment, the upper cap 220 may be positioned above the vent 210. A region of the outer surface and the outer upper surface of the upper cap 220 may be surrounded and fixed by the vent 210. The upper cap 220 may protrude upward and have a step, and the upper cap 220 may protrude upward and may be spaced apart from the vent 210. In a case where the vent 210 is ruptured, the protrusion portion 212 of the vent 210 may be separated from the lower cap 230 and may be moved such that the upper cap 220 and the vent 210 are spaced apart.

According to an embodiment, the upper cap 220 may include a terminal portion 222 and a plurality of discharge holes 224. The terminal portion 222 may be connected to an external terminal. The upper cap 220 may be electrically connected to the first electrode 112 through the first electrode tab 115, the lower cap 230, and the vent 210. The lower cap 220 may function as the first electrode 112, and the terminal portion (222) may be connected to the external terminal.

The discharge holes 224 may discharge gas transferred through the rupture portion 214 of the vent 210. As described above, the rupture portion 214 of the vent 210 may be ruptured by gas pressure, and the discharge holes 224 may allow gas to be discharged.

According to an embodiment, the insulating layer 240 may be positioned between the lower cap 230 and the vent 210. In addition to the configuration in which the vent 210 and the lower cap 230 are connected through the protrusion portion 212, the insulating layer 240 may be positioned on the outer upper surface of the lower cap 230 to insulate the vent 210 and the lower cap 230 so that the vent 210 and the lower cap 230 do not come into contact with each other. The lower cap 230 and the vent 210 may be electrically connected to the first electrode 112 through the first electrode tab 115. The first electrode 112 or the first electrode tab 115 may include at least a part of any one of the electrodes for a secondary battery according to the embodiments disclosed in FIGS. 3 to 6 of the present disclosure.

According to an embodiment, the gasket 140 may surround the cap assembly 130 and may be positioned between the case 120 and the cap assembly 130. For example, the gasket 140 may be ring shaped and positioned one side of the case 120. The gasket 140 may electrically insulate the cap assembly 130 connected to the first electrode 112 and the case 120 connected to the second electrode 113. In addition, the gasket 140 may protect the cap assembly 130 by buffering external impacts to the secondary battery.

FIG. 3 illustrates an electrode 300 for a secondary battery according to embodiments of the present disclosure. Among the features shown in FIG. 3, features described in FIGS. 1 and 2 are omitted. The electrode 300 for a secondary battery may correspond to the first electrode 112 or the second electrode 113 shown in FIG. 1.

Referring to FIG. 3, the electrode 300 for a secondary battery according to some embodiments of the present disclosure may include a substrate 310 including a conductive metal material, an uncoated portion 312, which is a region where the substrate 310 is exposed because an active material layer is not applied. The electrode 300 may also include a coated portion 314, which is a region where active material layers are applied onto both ends of the substrate 310. An electrode tab 320 is joined on the uncoated portion 312. In an embodiment where the substrate 310 is a positive substrate, the conductive metal material may include aluminum or an aluminum alloy. In an embodiment where the substrate 310 is a negative electrode substrate, the conductive metal material may include copper, a copper alloy, or nickel, a nickel alloy. In an embodiment, the uncoated portion 312 of the electrode 300 for a secondary battery may be formed in the central portion of the substrate 310, and the coated portion 314 may be formed on both sides of the uncoated portion 312. However, the arrangement or location of the uncoated portion 312 in the electrode 300 for a secondary battery is not limited to the depicted configuration. For example, the uncoated portion 312 may be formed on a terminal side of the substrate 310.

The electrode tab 320 may include a joined portion 322 joined to the uncoated portion 312 and a protrusion portion 324 protruding from one end of the uncoated portion 312. The protrusion portion 324 may include a plurality of first segmented portions 328 connected to the joined portion 322. The joined portion 322 may be joined on the uncoated portion 312 by welding. The protrusion portion 324 may protrude from one end (or the upper surface) of the uncoated portion 312 by a predefined distance or more. The first segmented portions 328 may be formed in the central portion of the protrusion portion 324. For example, the first segmented portions 328 may be formed by cutting or notching the protrusion portion 324 in the vertical or longitudinal direction of the electrode tab 320, but the forming method is not limited thereto.

Each of the first segmented portions 328 may be formed in a rectangular shape, but the first segmented portions may be formed in various shapes other shapes. In an embodiment, the first segmented portions 328 are adjacent to and spaced apart from each other. The widths of the first segmented portions 328 may be equal to each other. The protrusion portion 324 may include at least two segmented portions 328. In an embodiment, the electrode tab 320 may be a positive electrode tab, in which case the electrode tab 320 may include aluminum or an aluminum alloy.

With the configuration described above, the electrode tab 320 has a multi-align structure including multi-tabs having a small width or thickness, such as the first segmented portions, rapid insulation is possible in a case where an event such as an external short circuit occurs in the secondary battery.

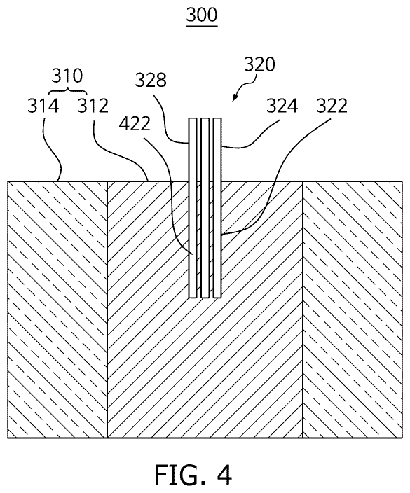

FIG. 4 illustrates an electrode 300 for a secondary battery according to further embodiments of the present disclosure. The electrode 300 for a secondary battery of FIG. 4 may correspond to the first electrode 112 or the second electrode 113 shown in FIG. 1.

Referring to FIG. 4, in the electrode 300 for a secondary battery according to embodiments of the present disclosure, the joined portion 322 of the electrode tab 320 may further include a plurality of second segmented portions 422 connected to a plurality of first segmented portions 328 formed on the protrusion portion 324. That is, the first segmented portions 328 and the second segmented portions 422 are connected to each other. Thus, the entire electrode tab 320 may be segmented into a plurality of small electrode tabs (so-called multi-align tabs). In an embodiment, the first segmented portions 328 and the second segmented portions 422 may be positioned side-by-side and spaced apart from each other by a predefined interval.

The first segmented portions 328 and the second segmented portions 422 may be formed by cutting the protrusion portion 324 and the joined portion 322 in the vertical or longitudinal direction of the electrode tab 320. But the present disclosure is not limited to such a forming method.

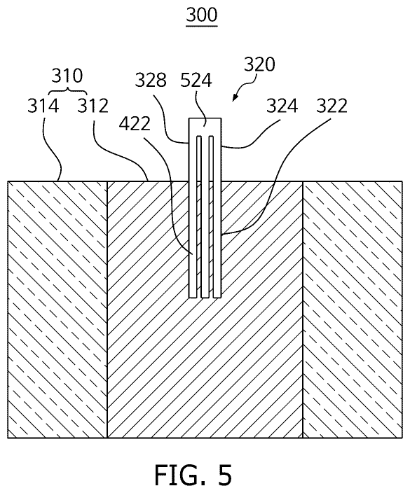

FIG. 5 illustrates an electrode 300 for a secondary battery according to embodiments of the present disclosure. The electrode 300 for a secondary battery of FIG. 5 may correspond to the first electrode 112 or the second electrode 113 shown in FIG. 1.

Referring to FIG. 5, in the electrode 300 for a secondary battery according to embodiments of the present disclosure, the protrusion portion 324 may further include a connecting portion 524 that connects the first segmented portions 328 at an end that is opposite to the joined portion 322 in the longitudinal direction of the first segmented portions 328. In an embodiment, the connecting portion 524 may have a rectangular shape. But the present disclosure is not limited thereto, and the connecting portion 524 may have various shapes. In an embodiment, the connecting portion 524 may be formed integrally with the electrode tab 320 and may be formed from the same material as the electrode tab 320. In another embodiment, the joined portion 524 may be formed by welding or bonding to the terminal of the electrode tab 320 or the first segmented portions 328 and may be formed from the same material as the electrode tab 320.

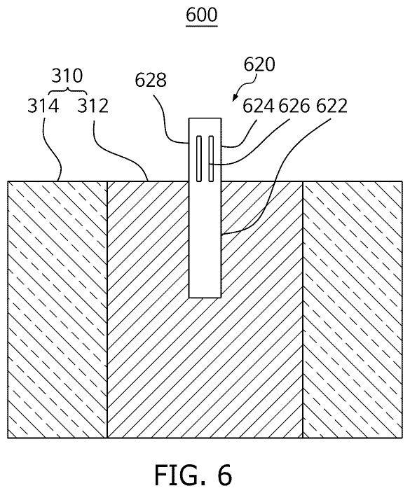

FIG. 6 illustrates an electrode 300 for a secondary battery according to some embodiments of the present disclosure. The electrode 600 for a secondary battery of FIG. 6 may correspond to the first electrode 112 or the second electrode 113 shown in FIG. 1.

Referring to FIG. 6, the electrode 600 for a secondary battery according to an embodiment of the present disclosure may include a substrate 310 including a conductive metal material, an uncoated portion 312 which is a region where the substrate 310 is exposed because an active material layer is not applied, a coated portion 314 which is a region where active material layers are applied onto both ends of the substrate 310, and an electrode tab 620 joined on the uncoated portion 312. In an embodiment where the substrate 310 is a positive substrate, the conductive metal material may include aluminum or an aluminum alloy. In an embodiment where the substrate 310 is a negative electrode substrate, the conductive metal material may include copper, a copper alloy, or nickel, a nickel alloy. The uncoated portion 312 of the electrode 600 for a secondary battery may be formed in the central portion of the substrate 310, and the coated portion 314 may be formed on both sides of the uncoated portion 312.

The electrode tab 620 may include a joined portion 622 joined to the uncoated portion 312 and a protrusion portion 624 protruding from one end of the uncoated portion 312 and including at least one penetration portion 626. The at least one penetration portion 626 may have a rectangular shape. The at least one penetration portion 626 may be spaced apart from the joined portion 622 by a predefined distance or more. The protrusion portion 624 may include a plurality of segmented portions 628 formed by segmenting a part of the protrusion portion 624 by the at least one penetration portion 626. The widths of the segmented portions 628 may be equal to each other. The joined portion 622 may be joined to the uncoated portion 312 by welding. The electrode tab 620 may be a positive electrode tab, in which case the electrode tab 620 may include aluminum or an aluminum alloy.

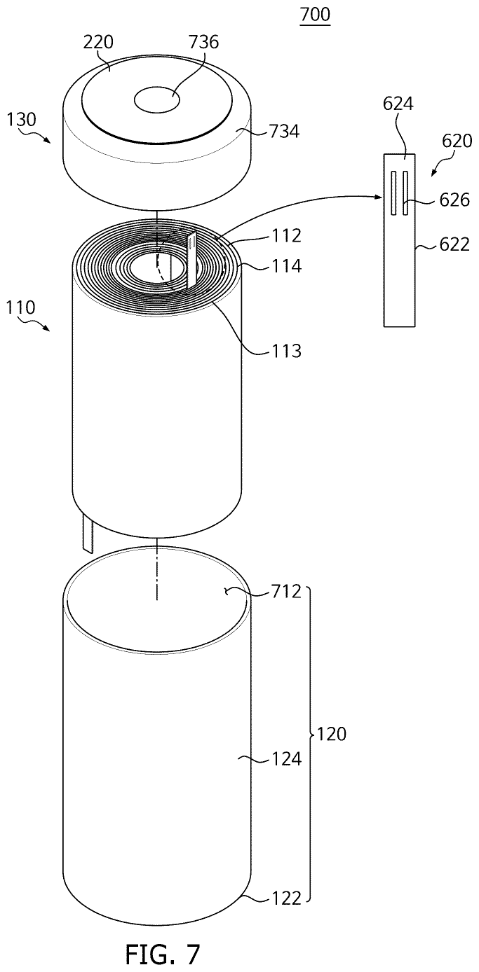

FIG. 7 illustrates an exploded perspective view of a secondary battery 700 including an electrode for a secondary battery as shown in FIG. 6. The secondary battery 700 disclosed in FIG. 7 may correspond to the secondary battery 100 disclosed in FIG. 1. Referring to FIG. 7, the secondary battery 700 may include a case 120, an electrode assembly 110, and a cap assembly 130. The case 120 may include a bottom portion 122, a sidewall portion 124 connected to the bottom portion 122, and an upper end opening 712 facing the bottom portion 122. The case 120 may accommodate the electrode assembly 110 that is inserted through the upper end opening 712. The upper end may refer to one end where the cap assembly 130 is positioned in the longitudinal direction of the secondary battery 700. Similarly, the lower end may refer to an opposite end of the upper end in the longitudinal direction of the secondary battery 700.

According to some embodiments of the present disclosure, the bottom portion 122 and the sidewall portion 124 in the case 120 may be formed integrally. Because of this, a separate process for joining the bottom portion 122 and the sidewall portion 124 in the secondary battery according to the present disclosure may not be required. In some embodiments of the present disclosure the case 120 may be cylindrical.

The electrode assembly 110 may include a first electrode 112 and a second electrode 113. The first electrode 122 may be a positive electrode. The second electrode 113 may be a negative electrode. The first electrode 122 may be formed at the upper end of the electrode assembly 110, and the second electrode may be formed at the lower end of the electrode assembly 110. Of course, the opposite is also possible, with the first electrode being formed at the lower end of the electrode assembly 110 and the second electrode being formed at the upper end of the electrode assembly 110. In other embodiments, both the first electrode 122 and the second electrode 113 may be formed at the upper end of the electrode assembly 110.

The cap assembly 130 may include an upper cap 220, an insulating member 734, and an electrolyte injection port 736. The upper cap 220 may be electrically connected to the first electrode 112 of the electrode assembly 110.

The first electrode 112 of the electrode assembly 110 may be electrically connected to the cap assembly 130. However, the present disclosure is limited thereto, and the second electrode 113 of the electrode assembly 110 may be electrically connected to the case 120.

The insulating member 734 may insulate between the upper cap 220 and the case 120. For example, the insulating member 734 may be formed to surround the upper cap 220, but the present disclosure is not limited thereto, and the insulating member 734 may be formed in various shapes as long as the insulating member 734 insulates between the upper cap 220 and the case 120.

The electrolyte injection port 736 may be formed to pass through the cap assembly 130. In particular, the electrolyte injection port 736 may be formed to pass through the upper cap 220. An electrolyte may be injected into the secondary battery 700 through the electrolyte injection port 736, and gas generated inside the secondary battery 700 may be discharged through the electrolyte injection port 736.

The secondary battery 700 may be a lithium secondary battery, a sodium secondary battery, etc. However, the scope of the present disclosure is not limited thereto, and the secondary battery 700 includes any type of battery that is capable of repeatedly providing electricity through charging and discharging.

According to some embodiments of the present disclosure, the electrode assembly 110 may be formed by alternately stacking and winding the first electrode 122 and the second electrode 113 with the separator 114. The first electrode 112 may be the electrode 600 for a secondary battery as disclosed in FIG. 6. The first electrode 112 may further include an electrode tab 620 as disclosed in FIG. 6. The electrode tab 620 may include a joined portion 622 joined to the uncoated portion 612 and a protrusion portion 624 protruding from one end of the uncoated portion 612 and including at least one penetration portion 626. The at least one penetration portion 626 may have a rectangular shape. The at least one penetration portion 626 may be spaced apart from the joined portion 622 by a predefined distance or more. The protrusion portion 624 may include a plurality of segmented portions 628 formed by segmenting a part of the protrusion portion 624 by the at least one penetration portion 626. The widths of the segmented portions 628 may be equal to each other. The joined portion 622 may be joined to the uncoated portion 612 by welding. The electrode tab 620 may be a positive electrode tab, in which case the electrode tab 620 may include aluminum or an aluminum alloy.

In FIG. 7, the electrode tab 620 is shown as having the same configuration as the electrode tab shown in FIG. 6, but the present disclosure is not limited thereto. For example, the electrode tab 620 of FIG. 7 may have the same configuration as the electrode tab 320 described with reference to FIGS. 3 to 5.

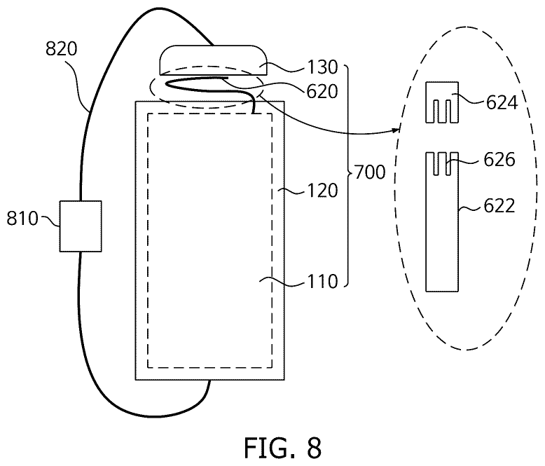

FIG. 8 illustrates a mechanism by which the secondary battery 700 is insulated in a low resistance region according to embodiments of the present disclosure. In some embodiments, the secondary battery 700 disclosed in FIG. 8 may correspond to the secondary batteries 100 and 700 disclosed in FIGS. 1 and 7.

Referring to FIG. 8, the secondary battery 700 according to embodiments of the present disclosure may be electrically connected to an external resistor 810 through an electric wire 820. When a short circuit event occurs due to the external resistor 810 during the operation of the secondary battery 700, each segmented portion positioned between the penetration portions 626 formed on the protrusion portion 624 of the electrode tabs 620 has a relatively narrow width, and thus has a very large resistance as compared to other portions of the electrode tab 620. Accordingly, the segmented portions positioned between the penetration portions 626 formed on the protrusion portion 624 of the electrode tab 620 may be easily ruptured. Thus, because the electrode tab having the multi-align structure is included, it is possible to provide an electrode for a secondary battery that is capable of rapid insulation when an event occurs due to an external short circuit. In embodiments of the present disclosure, the electrode tab 620 of the secondary battery 700 may be replaced with the electrode tabs 320, 420, and 520 disclosed in FIGS. 3 to 5.

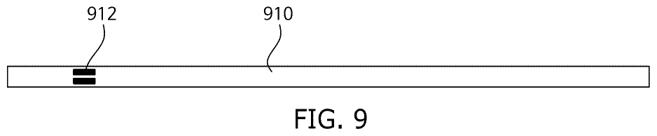

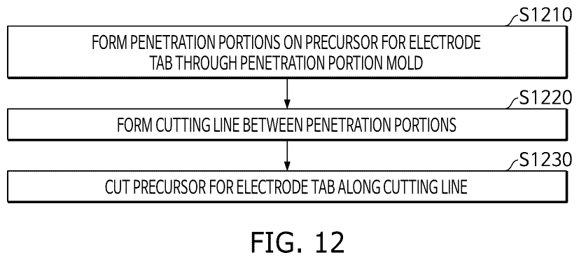

FIGS. 9 to 11 illustrate an example of a method of manufacturing an electrode tab according to an embodiment of the present disclosure. FIG. 12 illustrates a flowchart showing a method for manufacturing an electrode tab according to an embodiment of the present disclosure.

Referring to FIG. 12, the method of manufacturing an electrode tab according to an embodiment of the present disclosure may be initiated by an operation S1210 of forming a plurality of penetration portions on a precursor for an electrode tab through a penetration portion mold.

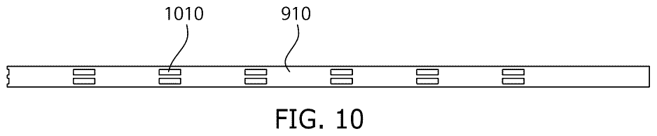

For example, referring to FIG. 9, a punching process may be performed through a penetration portion mold 912 that may form penetration portions at regular intervals on a precursor 910 for an electrode tab. Referring to FIG. 10, a plurality of penetration portions 1010 spaced apart at regular intervals may be formed through the punching process of FIG. 9.

In some embodiments, an operation S1220 of forming a cutting line between the penetration portions and an operation S1230 of cutting the precursor for an electrode tab along the cutting line may be performed.

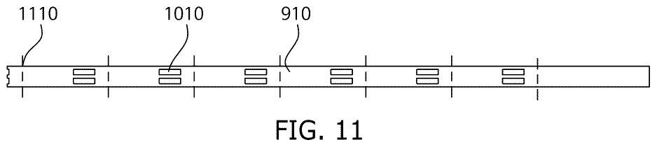

Referring to FIG. 11, after forming a plurality of cutting lines 1110 spaced apart at regular intervals so as to each include two penetration portions 1010, the precursor 910 for an electrode tab may be cut along the cutting lines 1110 to make electrode tabs according to an embodiment of the present disclosure.

The electrode tab manufactured by the method described above may be welded or joined to the uncoated portion of the electrode 600, for example, as described with reference to FIG. 6.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. An electrode for a secondary battery, the electrode comprising:
a substrate comprising a conductive metal material, the substrate including (i) coated portions to which an active material is applied at ends of the substrate and (ii) an uncoated portion where no active material is applied and the substrate is exposed;
an electrode tab joined to the uncoated portion of the substrate, wherein the electrode tab comprises:
a joined portion joined to the uncoated portion of the substrate; and
a protrusion portion protruding from the uncoated portion of the substrate and comprising a plurality of segmented portions connected to the joined portion.

2. The electrode as claimed in claim 1, wherein each of the segmented portions is rectangular shaped.

3. The electrode as claimed in claim 1, wherein the segmented portions are adjacent to and spaced apart from each other.

4. The electrode as claimed in claim 1, wherein widths of the segmented portions are equal.

5. The electrode as claimed in claim 1, wherein the protrusion portion comprises at least two segmented portions.

6. The electrode as claimed in claim 1, wherein the segmented portions are first segmented portions, and
wherein the joined portion comprises a plurality of second segmented portions, with each of the second segmented portions being connected to one of the first segmented portions.

7. The electrode as claimed in claim 1, wherein the protrusion portion further comprises a connecting portion connecting the segmented portions at an end that is away from the joined portion in a longitudinal direction of the segmented portions.

8. The electrode as claimed in claim 1, wherein the electrode tab is a positive electrode tab.

9. The electrode as claimed in claim 1, wherein the joined portion is joined to the uncoated portion by welding.

10. An electrode for a secondary battery, the electrode comprising:
a substrate comprising a conductive metal material, the substrate including (i) coated portions to which an active material is applied at ends of the substrate and (ii) an uncoated portion where no active material is applied and the substrate is exposed;
an electrode tab joined to the uncoated portion of the substrate,
wherein the electrode tab comprises:
a joined portion joined to the uncoated portion of the substrate; and
a protrusion portion protruding from the uncoated portion of the substrate and comprising at least one penetration portion.

11. The electrode as claimed in claim 10, wherein the at least one penetration portion is rectangular shaped.

12. The electrode as claimed in claim 10, wherein the at least one penetration portion is spaced apart from the joined portion.

13. The electrode as claimed in claim 12, wherein the protrusion portion comprises a plurality of segmented portions formed by segmenting a part of the protrusion portion by the at least one penetration portion.

14. The electrode as claimed in claim 13, wherein widths of the segmented portions are equal.

15. The electrode as claimed in claim 10, wherein the electrode tab is a positive electrode tab.

16. The electrode as claimed in claim 10, wherein the joined portion is joined to the uncoated portion by welding.

17. A secondary battery comprising:
an electrode assembly comprising a first electrode, a second electrode, and a separator positioned between the first electrode and the second electrode;
a case accommodating the electrode assembly and comprising a bottom portion electrically connected to the second electrode, a sidewall portion connected to the bottom portion, and an upper opening facing the bottom portion; and
a cap assembly joined to the case to cover the upper opening,
wherein the first electrode comprises:
a substrate comprising a conductive metal material, the substrate including (i) coated portions to which an active material is applied at ends of the substrate and (ii) an uncoated portion where no active material is applied and the substrate is exposed;
an electrode tab joined to the uncoated portion,
wherein the electrode tab comprises:
a joined portion joined to the uncoated portion of the substrate; and
a protrusion portion protruding from the uncoated portion of the substrate and electrically connected to the cap assembly, the protrusion portion comprising at least one penetration portion.

18. The secondary battery as claimed in claim 17, wherein the at least one penetration portion is rectangular shaped.

19. The secondary battery as claimed in claim 17, wherein the case is cylindrical.

20. The secondary battery as claimed in claim 17, wherein a portion positioned between the at least one penetration portion of the protrusion portion is configured to be ruptured when a short circuit occurs during operation of the secondary battery.
